(19) United States
(12) Patent Application Publication
(10) Pub. No.: US 2016/0137498 A1
(43) Pub. Date: May 19, 2016

(54) Method for Recovering Hydrochloric Acid from Metal Chloride Solutions with a High Iron Chloride Content

(71) Applicant: Kronos International, Inc., Leverkusen (DE)

(72) Inventor: Oliver Gnotke, Koeln (DE)

(21) Appl. No.: 14/795,273

(22) Filed: Jul. 9, 2015

(30) Foreign Application Priority Data
Jul. 8, 2014 (DE) 140023359

(51) Int. Cl. C01B 7/07; C01G 49/06

(52) U.S. Cl. CPC C01B 7/0737; C01G 49/06

(57) ABSTRACT

A method for recovering hydrochloric acid from concentrated metal chloride solutions displaying an iron chloride content of more than 50% by weight where the Fe³⁺/Fe²⁺ ratio is at least 0.2 by a) spray granulation of the metal chloride solution at temperatures of 150° C. to 300° C. where at least part of the iron chloride is converted into iron oxide by hydrolysis, and pellets and HCl-containing gas are produced; b) pyrohydrolysis of the pellets in a reactor at temperatures of more than 550° C. in which context HCl-containing gas is produced; and c) recovery of hydrochloric acid from the HCl-containing gases produced.

### RELATED APPLICATIONS

This application claims the benefit of EP Patent App. No. 14002335.9 filed Jul. 8, 2014.

### BACKGROUND

1. Field of the Invention

The invention relates to a method for recovering hydrochloric acid from concentrated metal chloride solutions that display a high iron chloride content and that particularly occur during the leaching of ores or the pickling of rolled steel products.

2. Technological Background of the Invention

For economic reasons, acid recovery is an essential feature of all processes relating to leaching or pickling with acids.

Numerous procedures are known, particularly for the regeneration of hydrochloric acid from the pickling solutions used to pickle steel prior to electroplating, for example. The most commonly used method is pyrohydrolysis, this being performed in a spray roaster or a fluidized-bed roaster at temperatures in the region of 800° C. In this context, the metal chlorides are converted into the oxides (e.g. Fe₂O₃) and HCl as quickly and completely as possible (Baerhold, F. H. & Lebl, A. “Recycling of acids via pyrohydrolysis: fundamentals and applications”, REWAS '99 Global symposium on recycling, waste treatment and clean technology, Vol. II (1999), pp. 1297-1307).

The facilities needed for reprocessing steel pickling agents are usually substantially smaller than those for reprocessing ore leaching solutions. For example, the largest installation for pickling solutions processes 18 m³/h iron chloride solution.

The size of the pyrohydrolysis apparatus is limited, owing to the high temperatures and the resultant, very large volumetric gas flow rate, meaning that this would require the use of numerous acid regeneration systems, connected in parallel, for ore leaching.

When leaching ilmenite ore for producing synrutile, the ilmenite is customarily subjected to a reduction process beforehand, during which the trivalent iron is converted to the bivalent state in order to improve the leachability of the iron; see the Austpac method (Walpole, E. A. & Winter, J. D. “The Austpac ERMS and EARS Processes for the Manufacture of High-Grade Synthetic Rutile by the Hydrochloric Acid Leaching of Ilmenite”, Chloride Metallurgy 2002—International Conference on the Practice and Theory of Chloride/Metal Interaction, Montreal, October 2002) and the Benelite and Murso methods (Sinha, H. N. “Chemical Processing of Titanium Minerals”, Australasian Mining and Metallurgy, 1993). According to these methods, the leaching solutions obtained contain iron chloride exclusively in the form of FeCl₂.

WO 1993/016000 A1 discloses a method for recovering hydrochloric acid from leaching solutions containing ferrous chloride, which provides for preconcentration and subsequent pelletisation of the chloride solution prior to pyrohydrolysis. Preconcentration takes place in a Venturi-tube or spray system and by subsequent contact with the superheated HCl-containing offgas of the fluidized-bed roaster. The metal chloride concentrate is subsequently pelletized and dried at temperatures of 130° C. to 150° C. The dried pellets are then cracked thermally in the fluidized-bed roaster (pyrohydrolysis). The HCl-containing offgas is passed through an HCl absorption column, and an azeotropic hydrochloric acid (18 to 20% by weight) is recovered.

This method has the advantage that a major part of the water is evaporated at low temperatures (drying temperature 130° C.-150° C.), meaning that several times (up to four times) the throughput can be achieved in an installation, compared to a single-stage fluidized bed.

Since significantly greater quantities of metal chloride solutions are generated during the acid leaching of iron-bearing ores (ilmenite) than when pickling steel, it is desirable to work with the highest possible acid concentration, since this keeps down the quantities of water to be evaporated during pyrohydrolysis, meaning that the specific energy demand is thus lower. When processing FeCl₂ solutions, however, the achievable HCl concentration is limited by the FeCl₂ solubility. If the FeCl₂ concentrations are increased beyond the solubility limit, this results in crystallisation, and thus clogging, in the area of the Venturi tube during preconcentration (Ahmad, K. & Lee, C. “Minimizing fuel cost during thermal regeneration of the hydrochloric acid lixiviant”, Hydrometallurgy 2003, Proceedings of the International Symposium honoring Professor Ian M. Ritchie, 5th, Vancouver, BC, Canada, Aug. 24-27, 2003 (2003), 1, 533-544).

Although FeCl₃ displays higher solubility than FeCl₂, it evaporates at the temperatures prevailing during pyrohydrolysis in the fluidized-bed roaster, then hydrolysing in the gas phase. Iron oxide particles as fine as dust are formed that, in turn, cannot be separated from the stream of HCl gas using the customary equipment (see: Baerhold & Lebl (1999), Page 1298, bottom).

However, the metal chloride solutions obtained during the leaching of iron-bearing ores not subjected to pre-reduction, often contain substantial quantities of the dissolved iron in trivalent form, this leading to the aforementioned problems during reprocessing. Reduction of the trivalent iron by adding scrap iron is occasionally used as a makeshift solution for this reason. However, this method entails high costs.

Peek (“Chloride pyrohydrolysis—Lixiviant regeneration and metal separation”, doctoral thesis, Delft University of Technology/NL, 1996, p. 74) describes a method for the pyrohydrolysis of FeCl₃ solution in a co-current spray roaster. However, the material has a high residual chloride content, this necessitating additional thermal treatment. Moreover, the material from spray roasters is very fine, meaning that it cannot be used directly for iron production.

### BRIEF DESCRIPTION OF THE INVENTION

The object of the invention is to indicate a method for the reprocessing of metal chloride solutions with a high iron chloride content, where the iron is partially present in trivalent state, and for the recovery of the hydrochloric acid, that overcomes the disadvantages of the known methods.

The object is solved by a method for recovering hydrochloric acid from a metal chloride solution with a concentration of at least 20% by weight, where the iron chloride component is more than 50% by weight, calculated as Fe, and an Fe³⁺/Fe²⁺ ratio of at least 0.2 is present, comprising the steps:

a) Spray pelletization of the metal chloride solution at temperatures of 150° C. to 300° C., preferably 150° C. to 250° C., where at least part of the iron chloride is converted into iron oxide by hydrolysis, and pellets and HCl-containing gas are produced,

b) Pyrohydrolysis of the pellets produced in Step a) in a reactor at temperatures of over 550° C., preferably over 800° C., in which context HCl-containing gas is produced,

c) Recovery of hydrochloric acid from the HCl-containing gases produced in Steps a) and/or b).

Advantages of embodiments of the invention include the fact that solutions with a high FeCl₃ content can be processed, and in that a major part of the water evaporation takes place at low temperatures, meaning that high throughputs are achieved in an installation. Further advantageous embodiments of the invention are indicated in the sub-claims.

### BRIEF DESCRIPTION OF THE DRAWINGS

For a more complete understanding of the present invention and for further advantages thereof, reference is now made to the following description taken in conjunction with the accompanying drawings in which:

FIG. 1: Schematic process flowchart, Version A

FIG. 2: Schematic process flowchart, Version B

FIG. 3: Scanning electron microscope image of a cut-open pellet from spray pelletisation as per the Example.

### DESCRIPTION OF THE PREFERRED EMBODIMENT

All data disclosed below regarding size in μm, etc., concentration in % by weight or % by volume, pH value, etc. are to be interpreted as also including all values lying in the range of the respective measuring accuracy known to the person skilled in the art. All data disclosed below regarding time, temperature, amount of components, concentration in % by weight, etc. are to be interpreted as also including all values lying in the range of the respective measuring accuracy known to the person skilled in the art. Unless otherwise stated, technical grades of the various materials were used in the preferred embodiments. The term “substantially free” is intended to connote that the particular material is not detected (i.e. is below the detection limit) using standard commercial tests and methodologies used in the industry as of the earliest priority date of this application.

The metal chloride solution used according to the invention displays a metal chloride concentration of at least 20% by weight, preferably at least 30% by weight, and particularly 40 to 60% by weight, where the iron chloride component is more than 50% by weight, and preferably more than 70% by weight. Moreover, the Fe³⁺/Fe²⁺ ratio is at least 0.2.

The method according to the invention is based on the method according to WO 1993/016000 A1, where, however, part of the iron chloride is present in the form of FeCl₃ and the pelletisation step is performed at a higher temperature of 150° C. to 300° C., such that at least part of the iron chloride is already hydrolysed and converted into iron oxide and HCl.

The metal chloride solution is preferably first preconcentrated, as in the known method according to WO 1993/016000 A1. Depending on the Fe³⁺/Fe²⁺ ratio, a substantially higher Fe concentration than the usual 120 g/l Fe can be set, without crystallisation occurring in the Venturi tube system. If a high percentage of the dissolved iron, all the way up to the entire quantity, is present in trivalent form—e.g. as a result of oxidative pretreatment of the ilmenite prior to leaching—the metal chloride solution can be preconcentrated to up to 60% by weight, without solid iron chloride forming.

The metal chloride solution, which may possibly have been subjected to preconcentration, is subsequently spray granulated at temperatures of 150° C. to 300° C., preferably 150° C. to 250° C., where the solution is injected into a fluidized bed via several spray nozzles (Step a). In the temperature window indicated, the FeCl₃ component is largely, and the FeCl₂ component partly, hydrolysed into iron oxide according to the following reaction scheme:

2 FeCl₃+3 H₂O→Fe₂O₃+6 HCl

2 FeCl₂+2 H₂O+0.5 O₂→Fe₂O₃+4 HCl

No evaporation of the FeCl₃ component occurs in this temperature range.

The largest possible proportion of the iron chloride is preferably hydrolysed.

The fluidized bed for spray granulation is preferably heated via a hot-gas generator. The inlet air temperature should be between 300° C. and 1,000° C., preferably>600° C. Iron oxide pellets, containing iron chloride and measuring roughly 1 to 5 mm, are formed. The addition of granulation nuclei in the form of recycled cyclone dust or other solids is advantageous.

Combustion in the hot-gas generator should preferably take place with only a slight excess of air. The avoidance of free oxygen in the offgas from spray granulation serves to minimise the Deacon reaction (formation of chlorine) that can occur at low temperatures.

The method according to the invention thus differs from the method according to WO 1993/016000 A1, where an FeCl₂ solution is preconcentrated and pelletized, without a hydrolysis reaction taking place. According to WO 1993/016000 A1, hydrolysis, and thus the formation of iron oxide from iron chloride, only takes place in the subsequent pyrohydrolysis step.

According to the invention, the pellets are conveyed into the pyrohydrolysis reactor by means of suitable transport apparatus (Step b). The pyrohydrolysis reactor is preferably a fluidized-bed reactor that is operated at a temperature of more than 550° C., preferably more than 800° C., and particularly at about 850° C., where the material remains in the fluidized bed for several hours (e.g. 3 to 10 hours). The remaining iron chlorides are hydrolysed there, as are most of the other metal chlorides, especially magnesium and calcium chloride. This makes it possible to obtain a very low residual chloride content of less than 0.1% by weight, such as is desirable for further processing in the metal industry. The granular metal oxide produced essentially contains iron oxide.

The streams of gas emerging from the fluidized bed for spray granulation (Step a) and the fluidized bed for pyrohydrolysis (Step b) contain the hydrochloric acid to be recovered. The HCl content of the gas stream emerging from the fluidized bed for spray granulation depends on the total iron chloride content and the Fe³⁺/Fe²⁺ ratio of the metal chloride solution entering the fluidized bed for spray granulation. The emerging gas streams are passed to HCl absorption columns according to the prior art.

In a special embodiment of the invention, the offgas from spray granulation and pyrohydrolysis is in each case passed into a packed column, where scrubbing liquid can additionally be fed back into the head of the column via a recirculation line by means of pumps, in order to ensure the necessary wetting of the packing. A heat exchanger can also be integrated in this cycle, in order to set advantageous isothermal conditions. Since the absorption of HCl is exothermic and the solubility of HCl in the scrubbing liquid declines with increasing temperature, higher hydrochloric acid concentrations can be achieved with cooling than without. The reaction gases are customarily extracted via fans located above the individual column heads. This also advantageously creates negative pressure in the system, this preventing harmful HCl-containing gases from escaping into the environment.

All in all, the invention makes it possible to recover hyperazeotropic hydrochloric acid with a concentration of>20% by weight, preferably>25% by weight, and particularly>30% by weight.

It can be derived from the vapour-liquid equilibrium that an HC1 concentration in the gas phase of at least 20% is necessary for a hydrochloric acid concentration of>20%, a gas-phase concentration of at least 55% for hydrochloric acid>25%, and a gas-phase concentration of at least 85% for hydrochloric acid>30% (gas-phase concentration calculated only for condensable components, i.e. HCl and water).

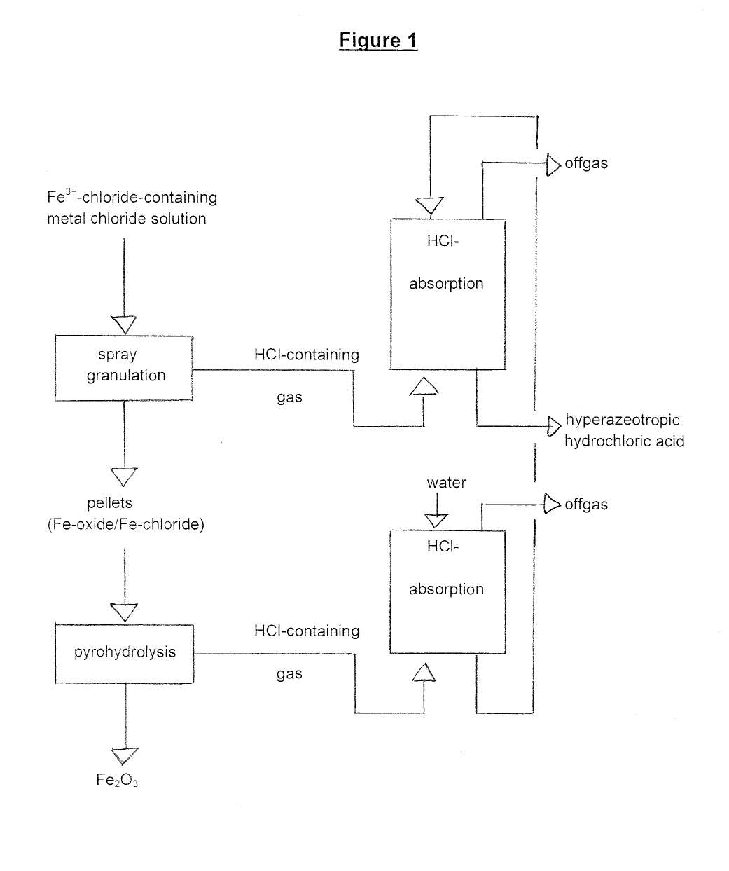

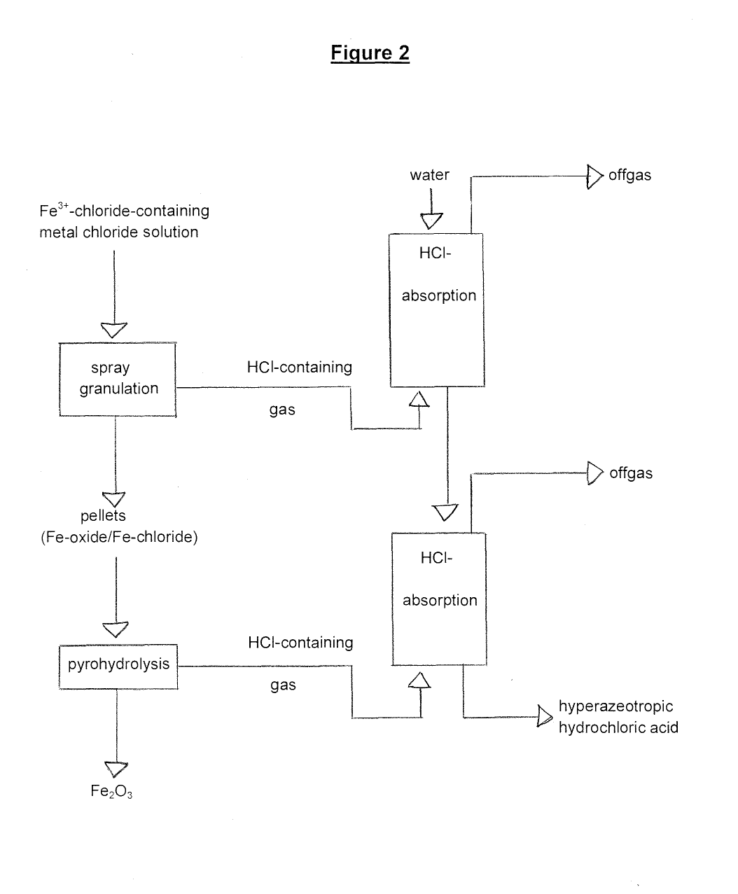

If the solution has a high FeCl₃ content (Fe³⁺/Fe²⁺>1), an HCl-rich gas stream is produced during spray granulation. It is passed to an absorption column to generate hyperazeotropic hydrochloric acid. The scrubbing liquid used is preferably the runoff of the HCl absorption column of the pyrohydrolysis stage (see FIG. 1: Process Version A). If the FeCl₃ content of the incoming solution is lower, the gas stream from pyrohydrolysis has the higher HCl content and is passed to an absorption column to generate hyperazeotropic hydrochloric acid. The scrubbing liquid used is then preferably the runoff of the HCl absorption column of the spray granulation stage (see FIG. 2: Process Version B).

Where appropriate, the offgas streams can be subjected to further scrubbing, in order to comply with statutory limits.

The method according to the invention demonstrates the following advantages, compared to the prior art:

Hyperazeotropic hydrochloric acid (>20% to more than 30% in the case of solutions with a high FeCl₃ content) can be recovered, meaning that the acid circuits required for ore leaching, and the necessary water evaporation, can be kept small.

Solutions with a high FeCl₃ content can be processed.

The resultant metal oxide is granular (>approx. 500 μm), essentially contains iron oxide and has a low residual chloride content, making it highly suitable as a raw material for iron production.

A major part of the water evaporation takes place at low temperatures, meaning that high throughputs can thus be achieved in an installation.

### EXAMPLE

The invention is described in more detail on the basis of the example below, although this is not intended to limit the scope of the invention.

Ilmenite ore from Norway was leached with 25% hydrochloric acid under boiling conditions, without prior reduction. The residue was filtered off.

There remained a metal chloride solution having the following composition:

| | |
|---|---|
| Free HCl | 4.4% by weight |
| FeCl₂ | 17.4% by weight |
| FeCl₃ | 8.5% by weight |
| MgCl₂ | 2.2% by weight |

Mn, Cr, V, Al and Ca chloride were each <1% by weight.

The solution was continuously injected into a fluidized bed for spray granulation with a diameter of approx. 30 cm for a period of 8 hours. The bed temperature was maintained at 160° C. by regulating the fuel supply.

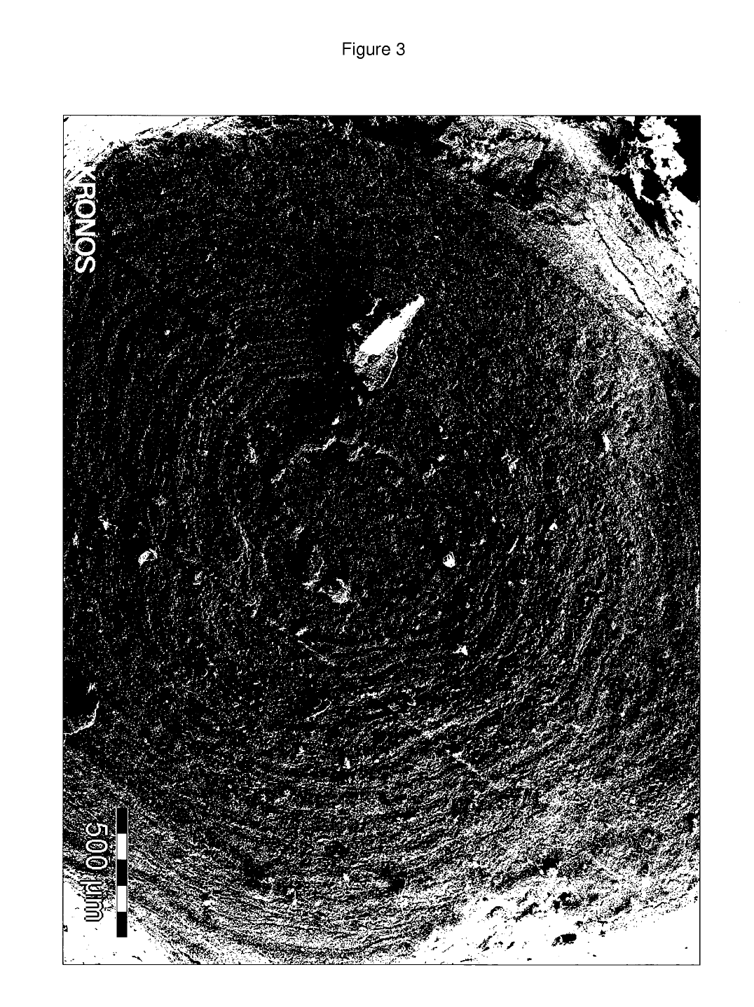

The resultant pellets were continuously discharged. The resultant offgas was scrubbed in a column. The resultant pellets had a diameter of 1 to 5 mm and an onion-like structure (see FIG. 3). Analysis by X-ray diffraction (XRD) revealed that ferrous chloride monohydrate (FeCl₂*H₂O) was the main component, along with haematite and magnetite. The most important minor constituent was magnesium chloride (5% by weight). No ferric chloride was found, this indicating complete conversion into iron oxide. The free moisture content was in the region of 3 to 4% by weight.

The offgas from the fluidized bed for spray granulation had the following composition:

| | |
|---|---|
| H₂O | 38% by volume |
| HCl | 5% by volume |
| N₂ | 45% by volume |
| O₂ | 7% by volume |
| CO₂ | 5% by volume |

The pellets were subsequently treated by pyrohydrolysis in a fluidized bed. The fluidized bed had a diameter of 10 cm, was heated externally and preheated to 950° C. by direct addition of fuel (coal dust) to the fluidized bed. Roughly 3 kg of the pellets were then metered into the fluidized bed over a period of roughly 3 hours. The temperature was maintained at a constant 950° C. by adding further fuel. Addition and heating were stopped at the end of this time. The treated pellets contained 90% by weight Fe₂O₃ and 5.7% by weight MgO. The other constituents occurring were Mn, Cr, V, Al and Ca oxide, each with<1% by weight. The total chlorides content was below 0.5% by weight. The mean diameter of the pellets (d₅₀ mass-related) was roughly 800 μm, the bulk density being 2,300 kg/m³.

The offgas from the fluidized bed for pyrohydrolysis was first quenched to roughly 100° C. by injecting water and then collected in a column into which water was fed. The offgas from pyrohydrolysis had the following composition before and after quenching:

| | Before quenching | After quenching |
|---|---|---|
| H₂O | 19% by volume | 51% by volume |
| HCl | 17% by volume | 10% by volume |
| N₂ | 56% by volume | 34% by volume |
| O₂ | 2% by volume | 1% by volume |
| CO₂ | 6% by volume | 4% by volume |

Absorption resulted (equilibrium state, adiabatic conditions, i.e. without cooling) in an HCl concentration of roughly 23% in the runoff.

The above descriptions of certain embodiments are made for the purpose of illustration only and are not intended to be limiting in any manner. Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is claimed is:

1. A method for recovering hydrochloric acid from a metal chloride solution displaying a concentration of at least about 20% by weight, an iron chloride content of more than about 50% by weight, calculated as Fe, and an Fe3+/Fe2+ ratio of at least about 0.2, comprising the steps:
a) Spray granulation of the metal chloride solution at temperatures of about 150° C. to about 300° C. where at least part of the iron chloride is converted into iron oxide by hydrolysis, and pellets and HCl-containing gas are produced;
b) Pyrohydrolysis of the pellets produced in Step a) in a reactor at temperatures of more than about 550° C., in which context HCl-containing gas is produced; and
c) Recovery of hydrochloric acid from the HCl-containing gases produced in Steps a) and/or b).

2. The method of claim 1 wherein the temperature in step a) is from about 150° C. to about 250° C.;

3. The method of claim 1 wherein the reactor temperature in step b) is more than 800° C.,

4. The method of claim 1 wherein the hydrochloric acid is recovered with a concentration of greater than about 20% by weight.

5. The method of claim 4 wherein the hydrochloric acid is recovered with a concentration of greater than about 25% by weight.

6. The method of claim 5 wherein the hydrochloric acid is recovered with a concentration of greater than about 30% by weight.

7. The method of claim 1 wherein in step c) includes further recovering a granular metal oxide that is essentially iron oxide.

8. The method of claim 7 wherein the granular metal oxide obtained is used for iron production.

9. The method of claim 7 wherein:
the temperature in step a) is from about 150° C. to about 250° C.;
the reactor temperature in step b) is more than 800° C., the hydrochloric acid is recovered with a concentration of greater than about 20% by weight; and
the metal chloride solution has an Fe3+/Fe2+ ratio of greater than about 1.

10. The method of claim 9 wherein the spray granulation is performed in a fluidized bed and the pyrohydrolysis is performed in a fluidized-bed reactor.

11. The method of claim 1 wherein the metal chloride solution is provided by ore leaching.

12. The method of claim 1 wherein the metal chloride solution has an Fe3+/Fe2+ ratio of greater than about 1.

13. The method of claim 1 wherein the spray granulation is performed in a fluidized bed.

14. The method of claim 1 wherein the pyrohydrolysis is performed in a fluidized-bed reactor.
